(19) United States
(12) Patent Application Publication
(10) Pub. No.: US 2011/0002127 A1
(43) Pub. Date: Jan. 6, 2011

(54) OPTICAL ELEMENT AND MANUFACTURING METHOD THEREFOR

(75) Inventors: Michael Johan Ferdinand Marie Ter Laak, Eindhoven (NL); Norbertus Antonius Maria Sweegers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/865,455

(22) PCT Filed: Feb. 5, 2009
(86) PCT No.: PCT/IB09/50474

§ 371 Date: Jul. 30, 2010

(30) Foreign Application Priority Data
Feb. 8, 2008 (EP) 08151217.0

(51) Int. Cl. F21V 7/00; G02B 1/10; B05D 5/06

(52) U.S. Cl. 362/296.01; 359/584; 427/162

(57) ABSTRACT

A method for manufacturing optical elements (5), comprising the steps of providing (100) an optical sheet (1); coating (103) a reflective layer (4) on the optical sheet (1); and forming (102) a first set of tracks (3), each having a first width, across the optical sheet (1) to divide the optical sheet into a plurality of optical elements (5).

### TECHNICAL FIELD OF THE INVENTION

The present invention relates to an optical element and to a method for manufacturing such an optical element. Further the present invention relates to a light output device comprising such an optical element.

### BACKGROUND OF THE INVENTION

Optical elements comprising light-emitting diodes (LEDs) are among the most efficient and robust light sources currently available. Illumination requires white color light sources, in particular white light sources of high color rendering properties. Various attempts have been made to make white light emitting illumination systems by using LEDs as radiation sources.

One method of obtaining white light is to use blue LEDs and convert part of the emitted blue light to yellow light (wavelength spectrum at about 580 nm). Since yellow light stimulates the red and green receptors of the eye, the resulting mix of blue and yellow light gives the appearance of white.

Typically, this is done by arranging an optical element containing a wavelength converting material, such as a phosphor-containing material on the LED such that part of the light emitted by the LED is absorbed by the phosphors and is emitted as light of a wavelength different from that of the absorbed light.

However, one problem associated with such an arrangement is the color homogeneity of the light provided. Light emitted from the edges of the LED and at oblique angles from the LED will not pass through the same thickness of wavelength converting material as light emitted in a forward direction. Hence, typically the degree of conversion of light exiting through the lateral sides of the material is lower than for the light exiting through the front surface of the material. In fact, similar problems may occur for other kinds of optical elements as well, such as lenses, protective windows etc—some of the light emitted by the light-source may be lost due to emission in an unwanted direction.

One approach to prevent the emitting of light from the edges of the optical element, is disclosed in WO 2006/048064. This reference describes an LED arrangement comprising an LED chip surrounded by a color-converting material, which is arranged on top and on the lateral sides of the LED. A reflector laterally surrounds the color converting material. The maximum distance between the LED chip and the reflector is 0.5 mm. Light emitted on the sides of the LED will be reflected by the reflectors, whereby this light is allowed to be wavelength-converted.

Drawbacks of the optical element in WO 2006/048064 include that the manufacture of such a device is difficult, time-consuming and expensive. The specific physical shape of the color converting material implies that it has to be formed on site for each one of the light emitting diodes, hence hampering mass production of such devices.

### SUMMARY OF THE INVENTION

In view of the above-mentioned and other drawbacks of the prior art, a general object of the present invention is to provide an improved optical element and, in particular an optical element that prevents light from being emitted in other directions then required directions.

Another object of the present invention is to provide such an optical element which is easy and inexpensive to manufacture, thereby enabling mass production of such optical elements.

These and other objects that will be apparent from the following summary and description are achieved by an optical element and a method for manufacturing an optical element, according to the appended claims.

Thus in a first aspect, the present invention relates to a method for manufacturing optical elements, which generally comprises the steps of providing an optical sheet; coating a reflective layer on the optical sheet and forming a first set of tracks each having a first width across the optical sheet to divide the optical sheet into a plurality of optical elements.

The optical sheet is advantageously a wavelength converting plate such as a ceramic phosphor plate or any other transparent or translucent material, including glass, polymers, such as epoxy, and hybrids, such as sol-gels. The optical sheet may for example be formed by casting, pressing, molding, machining or sol gelling.

The reflective layer could, for example, be provided in the form of a resin filled with reflective particles, such as a TiO₂-filled epoxy. However, the reflective layer may alternatively be provided as a metallic layer, a reflective multi-layer structure of as a layer of other materials having a high reflectivity, such as Al₂O₃, or MgO. The reflective layer may, for example, be applied by casting, raking, spin coating, evaporation, sputtering, spraying, capillary filling etc.

The first set of tracks may, for example, be formed by sawing, scribing, laser cutting or water jet cutting.

The optical sheet may advantageously be provided on a carrier for holding said optical elements in position after the formation of the first set of tracks.

Through this provision of a carrier, the handling of the optical sheet is facilitated, which improves the mass-producability of the optical elements.

The carrier may, for example, be provided in the form of a carrier tape, a sheet of glass, a wax, an ice, a glue or a foil.

It should be noted that the steps of the method according to the invention may be performed in any order.

According to one embodiment of the invention, the step of coating the optical sheet may be performed before the step of forming the set of tracks to divide the optical sheet and thus form a plurality of optical elements.

The resulting optical elements will have a top face that is coated with a reflective material and edges that are uncoated. In this way, an optical element is provided that prevents passage from a bottom face to the top face thereof, and instead allows for emission of light through the edges of the optical element. Such optical elements are, for example, useful in side-emitting LED-assemblies.

According to another embodiment of the present invention, the step of forming the first set of tracks is performed prior to the step of coating the reflective layer, and the method further comprises the steps of: removing a thickness, at least corresponding to the thickness of the reflective layer, from the optical sheet; and forming a second set of tracks inside the first set of tracks, the second set of tracks being narrower than the first set, thereby forming a plurality of optical elements having reflectors formed on the edges thereof.

The present inventors have realized that an optical element, such as a wavelength converting plate, with reduced or eliminated leakage of light can be formed in a very cost-efficient manner by first cutting the optical sheet to expose the edges of the optical elements, apply a reflective layer across the surface of the (cut) optical sheet, thin the optical sheet to expose the top faces of the optical elements and finally separate the optical elements by cutting between the optical elements in such a way that reflective material remains on the edges of the optical elements.

In an optical element manufactured through the method according to the present embodiment of the invention, light coupled into the optical element will be reflected at the edges thereof to eventually exit the element through the top face thereof, which leads to an improved color homogeneity and efficiency.

Moreover, the method according to the invention may further comprise the step of thinning the optical sheet prior to coating to remove defects, such as sub-surface irregularities, remaining from the formation of the optical sheet and thereby improve the homogeneity of the optical sheet.

Typically thinning methods for example include grinding, laser beam machining and etching.

According to a second aspect of the present invention, the above-mentioned and other objects are achieved through an optical element comprising an at least partly optically transparent plate having first and second opposing faces and a plurality of lateral edge surfaces, wherein said first face is a receiving face for receiving light from a light-source and at least one of said second face and said edge surfaces is coated with a reflective material.

In embodiments of the present invention, said at least partly optically transparent plate may be a ceramic-based wavelength converting plate.

The term “wavelength converting” as is used herein, refers to a material or element that absorbs light of a first wavelength resulting in the emission of light of a second, longer wavelength. In particular, the term relates to both fluorescent and phosphorescent wavelength conversion.

According to one embodiment of the optical element of the invention, each of the edge surfaces is coated with the reflective material. Since the optical element according to the present invention has been separated from an optical sheet, the edge surfaces correspond to the sides of the tracks formed in the optical sheet. The edge surfaces of the optical element according to the present embodiment will therefore be easily distinguishable from any surface formed by direct application of a reflective material on an already singularized optical element.

According to another embodiment of the optical element of the invention, the second face of the optical element may be coated with the reflective material.

The optical element according to the present invention may, furthermore, advantageously be included in a light-output device, further comprising a light-source arranged to emit light towards the receiving face of the optical element.

The light-source may advantageously comprise at least one LED, and the light-output device may be a light-emitting device used for illumination or an ambience creating device that outputs light for the purpose of creating a desired ambience.

### BRIEF DESCRIPTION OF THE DRAWINGS

These and other aspects of the present invention will now be described in more detail, with reference to the appended drawings showing currently preferred embodiments of the invention, wherein:

FIG. 1 is a flowchart schematically illustrating a first method for manufacturing optical elements according to one embodiment of the present invention;

FIGS. 2a-g schematically illustrate the state of the optical elements after the corresponding method steps in FIG. 1;

FIG. 3 is a flowchart schematically illustrating a method for manufacturing optical elements according to a second embodiment of the present invention; and

FIGS. 4a-e schematically illustrate the state of the optical elements after the corresponding method steps in FIG. 3.

### DETAILED DESCRIPTION OF A PREFERRED EMBODIMENT OF THE INVENTION

In the following description, the present invention is described with reference to optical elements in the form of ceramic-based wavelength converting platelets.

It should be noted that this by no means limits the scope of the invention, which is equally applicable to other forms of at least partly transparent or translucent optical elements.

Furthermore, although single exemplary ways of performing the respective steps of the method according to the invention are described herein, the skilled person would readily be able to perform these steps by means of equivalent techniques known in the art.

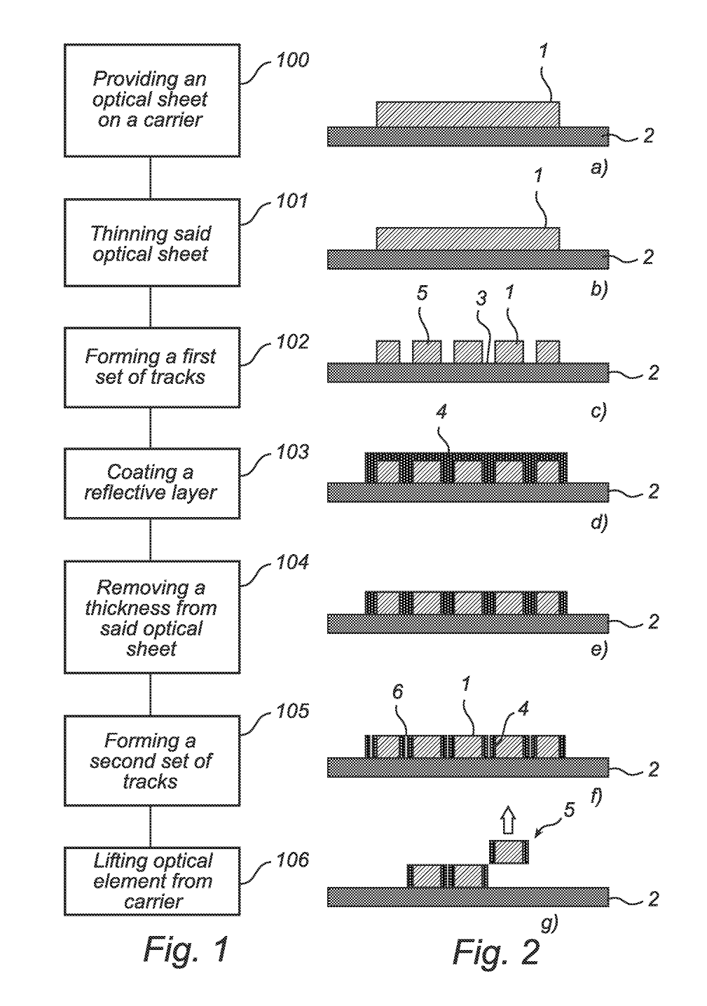

A first embodiment of the method for the manufacturing of an optical element of the present invention is illustrated in FIG. 1, and FIGS. 2a-g, respectively, illustrate the states of the optical element following the respective method steps.

With reference to FIG. 1, an optical sheet 1 on a carrier 2 is provided in a first step 100. As described above, the optical sheet 1 could be a ceramic-based wavelength converting plate.

In a subsequent step 101, the optical sheet 1 is thinned to intermediate thickness, which for example could be done by grinding by a grinding spindle. Alternative thinning methods are laser beam machining or etching.

Moving on to the next step, 102, a first set of tracks 3 is formed by cutting through the optical sheet 1. The tracks divide the optical sheet 1 in a plurality of wavelength converting plates 5, and each track 3 has a first width.

With reference to FIG. 2c and continued reference to FIG. 1, the optical elements are coated with a reflective layer in step 103. As described above, the reflective layer 4 is typically applied by casting, raking or spin coating. The reflective layer 4 is provided on the edges of the optical elements 5 exposed in the tracks 3 as well as on the top of each wavelength converting plate 5.

Referring now to FIG. 1 and FIG. 2f, a sufficient amount of material is removed from the top surface of the optical sheet to expose the top faces of the optical elements. The amount of material removed at least corresponds to the thickness of the reflective layer 4. This process could be done by for example grinding, laser beam machining or etching.

Moving on to next step, 105, a second set of tracks 6 is formed inside the first set of tracks 3 by for example cutting using a thinner dice-blade than in the first cutting process. The second set of tracks is narrower than the first set and hence a plurality of optical elements 5 with reflectors formed on the edges thereof are achieved.

In the last step 106 the optical elements 5 are removed from the carrier. This may, for example, be done by picking the optical elements one by one of by. According to the method as described above, the optical elements may have reflective rims (not shown in FIGS. 2a-g) remaining due to the depth of the tracks extending into the carrier. These rims may be used for positioning of the optical elements 5 in relation to a light-source or another optical element, or, alternatively, the divided optical sheet 1 as shown in FIG. 2c could be transferred to another carrier and flipped, whereafter the remaining process steps can be performed. The result of such an operation will be flat optical elements without reflective rims.

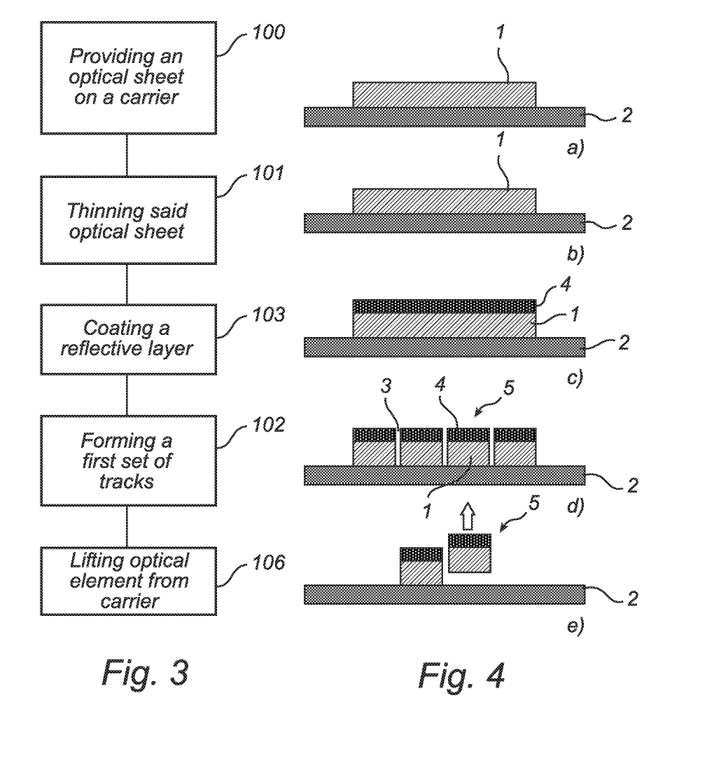

With reference to FIG. 3 and FIGS. 4a-e, there is shown an alternative embodiment of the manufacture of optical elements.

In a first part of the method, step 100, an optical sheet 1 is provided on a carrier 2. As described above the optical sheet 1 could be a ceramic-based wavelength converting plate, such as a luminescent plate.

In a second part of the method, step 101, the optical sheet 1 is thinned to intermediate thickness, which for example could be done by grinding by a grinding spindle. Alternative thinning methods are laser beam machining or etching.

With reference to FIG. 4c and continued reference to FIG. 3, the optical sheet 1 is now coated with a reflective layer 4 in step 103. As described above, the reflective layer 4 is typically applied by casting, raking or spin coating.

Moving on to next step, step 102 in FIG. 3, a first set of tracks 3 is formed by cutting, for example by dicing, through the reflective layer 4 and through the optical sheet 1 and party through the carrier 2. Each track 3 having a first width across said optical sheet 1 to divide said optical sheet 1 in a plurality of wavelength converting plates 5.

The last step in this embodiment, step 106 in FIG. 3 is to remove the carrier 2 from the optical element 5. An alternative method could be to remove the optical elements 5 one by one, when they is to be used for example in an light output device, from the carrier.

The person skilled in the art realize that the present invention by no means is limited to the preferred embodiments described above. On the contrary, modifications and variations are possible within the scope of the appended claims. For example the optical element is not limited to the application to a specific type of light-source (LED), but can be used in any application where it is desired to output light in a certain direction.

1. A method for manufacturing optical elements , said method comprising the steps of:
providing an optical sheet;
coating a reflective layer on said optical sheet; and
forming a first set of tracks, each having a first width, across said optical sheet to divide said optical sheet into a plurality of optical elements.

2. A method according to claim 1, wherein said optical sheet is provided on a carrier for holding said optical elements in position after the formation of said first set of tracks.

3. A method according to claim 2, wherein said step of forming the first set of tracks is performed prior to said step of coating, the method further comprising the steps of:
removing a thickness, at least corresponding to the thickness of the reflective layer, from the optical sheet; and
forming a second set of tracks inside said first set of tracks, said second set of tracks being narrower than said first set, thereby forming a plurality of optical elements having reflectors formed on the edges thereof.

4. A method according to claim 1, further comprising the step of:
thinning said optical sheet prior to coating.

5. An optical element comprising an at least partly optically transparent plate having first and second opposing faces and a plurality of lateral edge surfaces, wherein said first face is a receiving face for receiving light from a light-source and at least one of said second face and said edge surfaces is coated with a reflective material.

6. An optical element according to claim 5, wherein said at least partly optically transparent plate is a ceramic-based wavelength converting plate.

7. An optical element according to claim 5, wherein each of said edge surfaces is coated with said reflective material.

8. An optical element according to claim 5, wherein said second face is coated with said reflective material.

9. An optical element according to claim 5, wherein said reflective material is a resin filled with reflective particles.

10. A light output device comprising:
a light source arranged to emit light, and an optical element according to claim 5 arranged to receive light emitted by said light source.

11. A light output device according to claim 10, wherein said light source is a light emitting diode.
